(19) United States
(12) Patent Application Publication
(10) Pub. No.: US 2011/0095538 A1
(43) Pub. Date: Apr. 28, 2011

(54) WIND AND HYDROPOWER PLANT

(76) Inventor: JOSEPH AKWO TABE, Silver Spring, MD (US)

(21) Appl. No.: 12/607,086

(22) Filed: Oct. 28, 2009

(51) Int. Cl. F03D 9/00

(52) U.S. Cl. 290/55

(57) ABSTRACT

An enclosed wind and hydropower plant comprising apparatus being configured for directing environmental wind into a building structure for the operation of wind turbine assembly, and for generating wind when there is no environmental wind to operate the enclosed turbine assembly.

THIS APPLICATION CLAIMS PRIORITY BENEFITS UNDER 35 USC 119 AND UTILITY APPLICATION Ser. No. 12/383,569, which is a continuation of Ser. No. 11/821,776 filed Jun. 25, 2007, which is a continuation of Ser. No. 10/660,473, Filing Date Sep. 12, 2003, now U.S. Pat. No. 7,271,720, which claims priority from PROVISIONAL APPLICATION, Ser. No. 60/426,800, Filing Date Nov. 18, 2002. Wind plant, hydropower plant, or a combination of both wind plant and hydropower plant, and each preceding application being incorporated by reference herein in their entirety.

### FIELD OF THE INVENTION

Embodiments relate to wind power apparatus, methods, and systems for generating renewable energy. Embodiments relate to hydropower apparatus, methods, and systems for generating renewable energy. Embodiments further comprise wind plant, hydropower plant, or a combination of both wind plant and hydropower plant, and each preceding methods and systems provides apparatus for generating renewable electrical energy. Embodiments further provide methods and systems for energy storage medium.

### BACKGROUND OF THE INVENTION

Wind is a form of solar energy caused by the uneven warming of the earth's surface. The air masses have different temperatures and pressures, and are constantly moving to find a balance. The higher the difference in pressure, the swifter the air moves and the stronger the wind. Embodiments provide apparatus for controlling the abundance of energy through a controllable inflow of air from a wind control device, including a ventilation system to propel wind turbine assembly for generating renewable electrical energy. Some embodiments provide a combination of wind and hydropower apparatus, methods, and systems comprising concentrated devices configuration through high pressured wind generating device and water pump apparatus in communications with at least turbine assemblies.

Embodiments further provide energy storage medium comprising microfiber material which can be configured with silicon substrate. Embodiments further provide substrate-microfiber comprising miniaturized non ferrous materials which can be embedded in the silicon substrate. Embodiments further provide substrate-microfiber comprising energy transport platform and include glass.

In a wind and power apparatus, the wind's force is gathered by the apparatus such as, for example, blades of turbines, causing these blades to rotate and creating “mechanical energy.” The mechanical wind energy can be converted into different forms of energy, such as, for example, electrical energy. Wind power apparatus can include, or can be associated with a generator assembly for converting mechanical energy into electrical energy.

Some embodiments of the disclosure further relate to the awareness of producing abundance of energies without affecting the environment. Certain embodiments provide methods and systems that teach the importance of harvesting these energies for the production of renewable electrical energy without massive consumption of other energies, such as water. Still, some embodiments further include the application of enclosed wind turbine assembly within a building structure and generating a controlled wind to propel the turbine blades for the turbine assembly for producing renewable electrical energy. Yet other aspect of embodiments would educate the public about the importance of these teachings, which include regenerative dams responsive to concentrated hydropower. Some of the negative consequences of constructed dams can be eliminated through the understanding of the application of disclosed embodiments. The potential loss of wind and water flow and the natural environment that may be destroyed or diminished from the diversion of wind and water from its natural path to the hydro-generating stations of conventional wind and hydropower plant can be eliminated. The massive water consumptions of other power plants such as nuclear power plant, parabolic solar plant, and coal fired plant can be eliminated with the implementation of disclosed embodiments.

Furthermore, exposable wind energy doesn't really reduce pollution completely at 100% when the wind is not available because other fossil-fired generating units would be running on a temporal basis until the wind is available again. Ice throw may occur with the conventional exposable wind turbine, and because ice buildup slows a turbine's rotation though being sensed by a turbine's control system, the buildup would still cause the turbine to shut down, thereby turning the fossil power plant on and adding more pollutant into the environment. The blades of conventional exposable turbine farms create lots of turbulences which can mix air up and down and create warming and drying effect near the ground. The rotating blades of conventional exposable wind mill could redirect high-speed winds down to the earth's surface, boosting evaporation of soil moisture. Land transportation represents yet another potential limiting factor for wind turbine growth.

Developing wind farms on mountains that are already being used for ski resorts are not the idle solutions because these mountains are touristic sites. Exposable wind turbines, such as those typically installed at conventional wind farms, can interfere with radio or TV signals if the turbines are in the line of sight, say between a receiver and the signal source. Also, conventional wind farms interfere with radar signals because radar basically are designed to filter out stationary objects and display moving ones, and the moving wind turbine blades can create radar echoes. The embodiments provide enclosed turbine power plant to further eliminate these problems. Conventional exposable wind farm further interferes with environmental safety and modifying existing apparatus to compensate for the existence of conventional exposable wind farm would dictate cost and reduce technological advancements. Exposable wind farm near airports or military airfields would create further issues that are being eliminated in disclosed embodiments. Though it is visual that we have to move away from conventional fossil fuels like coal and oil and look at alternatives, energy sources, conventional exposable wind farms still have unaddressed environmental issues which are being addressed in disclosed embodiments.

Additionally, conventional hydropower plants utilize embankments which usually are built to reserve water and create differences in water levels. Lakes in high altitudes are costly and also used for the same purposes (the storage of potential energy within the water as the “fuel” for power generation). Five factors are usually used to determine the kind of dam to be built, this include:
the height of water to be stored,
the shape and size of the valley.
the geology of the valley walls and floor,
the availability, quality and cost of construction materials, and
The availability and cost of labor and machinery.

Conventional power stations contain turbines and generators usually built near the downstream side of the dam. With the conventional dams, pipes or channels are used to direct water from the storage to the stations. Within the station, water pushes the turbine that generates electrical energy and then exits through the tailrace. These processes have existed for long and new researches are needed for the development of power plants that are cost effective. Although current conventional Wind and Hydropower plants have many advantages, there are still quite a few setbacks. The increase of water level could destroy the habitat for humans and other species by flooding of lands. Additionally, flooding also causes soil erosion on the watershed's wall. This could impact the vegetation of the area. Along with the disruption of natural orders, flooding also could threaten historical landmarks found alongside the liver systems. Moreover, building a hydro dam proximate to any city is a potential time bomb for that city if located downstream. Historically, conventional hydropower plants impact water quality and may cause low dissolved oxygen levels in the water. With current conventional hydropower plants, maintaining minimum flow of water downstream are critical for the survival of riparian habitats. Electricity from these plants could not be produced when the water is unavailable. Additionally, humans, flora, and fauna may lose their natural habitats.

In addition, there are costs and considerations associated with constructing conventional hydro electric dam, this include:
1. A dammed river, which means that a valley must be flooded. This may have an erect on erosion and may cause loss of habitat to local wildlife. Farmland may also be lost.
2. Special slipways for Hydro electric dams to prevent fish from being swept into the works
3. In areas with unreliable rainfall for obvious reasons.
4. A lot of energy needs to go into the construction of the dam and turbines.
5. Directing a lot of expensive energy into the construction of Dams.

However, conventional wind and hydropower also have some benefits for the environment and for the people, such as:
The wind and water is a safe habitat for aquatic life and for wading birds
The darn also provides a source of wind and water for wildlife and farm animals in the surrounding area.
The artificial lake created by the dam has some tourism spin-offs for the local community—boating and fishing in particular (sometimes, the outflow wind and waters from the dam are warmer and fish thrive in them—The lakes can also be used for fish farms.
The power generated by this means is very clean and produce no carbon emissions.

Overall, these are effective mediums for producing renewable energy, but due to the reasons discussed above, such as the social, economic and environmental costs, it may be feasible for use in some towns and unfeasible for use in other towns. Disclosed embodiments can supplement the conventional wind and hydropower plant.

### SUMMARY OF THE INVENTION

Disclosed embodiments are further required for States with constant environmental emergencies. Embodiments provide transportable renewable energies. Disclosed embodiments present a new educational literature for producing energies on demand to add to the number of other existing programs. Embodiments teach ways to expedite the supply of renewable energy to reduce U.S dependence on foreign oil. Investment in wind and hydropower technology for disclosed embodiments worth building a plant to facilitate the process. The wind and hydropower plant would enable the study and installation of emergency transmission lines “Smart Lines” in all residential, industrial, and other construction areas.

Wind and Hydropower plant, in certain embodiments, include the generation of electrical energy through enclosed wind and water pressure. Embodiments further provide apparatus, which relates to wind and hydropower plant for generating transportable energy and for generating energy on demand. Some of disclosed embodiments further relate to wind and hydropower plant comprising enclosed turbine assemblies, exposable turbines and/or submersible turbine configuration, all incorporated in disclosed embodiments to provide apparatus for producing renewable electrical energy that can be stored and/or be transmitted on demand.

Conventional hydropower plants comprises of wicket gate mechanism, turbine governors, generator bearings, and lube oil system that usually force outage or force scheduled maintenance outage. Maintenance for these conventional plants further requires de-rating of hydroelectric turbines. The propulsion of random flow pressure on conventional hydropower plants is ineffective because controlling pressure rate of water for such malfunctioned dam could be catastrophe. Other conventional methodological power plants are not environmentally conducive because most require substantial amount of water consumption in other to produce electrical energy. For example, according to U.S. Department of Energy, a coal fired plant uses 110 to 300 gallons of water per megawatt hour: a nuclear plant uses between 500 and 1100 gallons/MWh: and a solar parabolic trough plant uses 760-920 gallons/MWh. These are waters that could benefit consumer supply chain and U.S medical and pharmaceutical industries. Disclosed embodiments address issue of water through concentrated pump pressured hydropower facility. The concentrated hydropower plant is an important innovation for solving the inherent scares of the habitants. Disclosed embodiments further provide apparatus for utilizing unpressured water to generate the needed pressure to generate the required electrical energy at particular periods. Disclosed embodiments further provide means for generating electrical power for industrial and commercial applications.

### BRIEF DESCRIPTION OF THE DRAWINGS

FIG. 1 is seen exemplary embodiments showing sections of a building structure 20 configured with device for generating operating wind.

FIG. 2 is seen embodiments of wind generating apparatus 100 disposed on the building structure 20 for operating the enclosed turbine assembly 200.

FIG. 3 is seen exemplary embodiments of the building structure 20 configured with apparatus comprising wind entrance 4 and exit ports

FIG. 4 is seen further exemplary embodiments of the building structure 20, multiple devices for generating operating wind, and the wind turbine assembly 200.

FIG. 5 is seen exemplary embodiments of a dam 600.

FIG. 6 is seen similar exemplary embodiments of the wind and hydropower plant 12.

FIG. 7 is seen further exemplary embodiments of the enclosed wind energy plant configured with solar power and wind energy generators for the wind and hydropower plant.

FIG. 8 is seen further exemplary embodiments of the solar power and wind energy generators for the enclosed turbine assembly.

FIG. 9 is seen further exemplary embodiments of the wind and hydropower plant disclosed with tunnel being configured with turbine assembly.

FIG. 10 seen further exemplary embodiments of the ventilation apparatus, the building structure, and the hydropower apparatus for the wind and hydropower plant.

FIG. 11 is seen further exemplary embodiments of the building structure and the turbine operation.

FIG. 12 is seen further exemplary embodiments of the wind and hydropower plant configured with tunnels and hydropower pipes.

FIG. 13 is seen exemplary embodiments of nanotechnology application comprising substrate-microfiber 724.

FIG. 14 is seen exemplary embodiments of energy medium.

FIG. 15 is seen further exemplary embodiments of the energy medium comprising energy storage apparatus 720.

FIG. 16 is seen further exemplary embodiments of the energy medium.

Referring to FIG. 17 is seen exemplary embodiments of a charge transport comprising microfiber material 710 being configured with silicon substrate 71

### DETAILED DESCRIPTION OF THE INVENTION

Embodiments include apparatus for an enclosed wind and hydropower plant configured for converting wind and kinetic energies into renewable electrical energy. Some embodiments described below relates to enclosed turbine assembly, solar energy, and hydropower. For example, in some embodiments, the apparatus as described comprises a power plant. In some embodiments, the apparatus as described comprises wind flow apparatus comprising a ventilation platform array. In certain embodiments, the apparatus as described comprises a fixed ventilation platform array. In other embodiments, the apparatus as described comprises a horizontal ventilation platform array. Still in some embodiments, the apparatus as described comprises a vertical ventilation platform array. Yet in other embodiment, the apparatus as described comprises an angular ventilation platform array. In some embodiments, the apparatus as described is a wind mill plant. In some embodiments, the apparatus as described is a hydropower plant. Still in certain embodiments, the apparatus as described is operatively configured with at least a solar power apparatus.

The terminology used herein is for the purpose of describing particular embodiments only and is not intended to be limiting of embodiments. As used herein, the singular forms “a”, “an”, “at least”, “each”, “one of”, and “the” are intended to include the plural forms as well, unless the context clearly indicates otherwise.

It would be further understood that the terms “include”, “includes” and/or “including”, where used in this specification, specify the presence of stated features, integers, steps, operations, elements, aid/or components, but do not preclude the presence or addition of one or more other features, integers, steps, operations, elements, components, and/or groups thereof. In describing example embodiments as illustrated in the drawings, specific terminology is employed for the sake of clarity. However, the disclosure of this patent specification is not intended to be limited to the specific terminology so selected and it is to be understood that each specific element includes all technical equivalents that operate and/or function in a similar manner. It would be further noted that some embodiments of the enclosed wind and hydropower plant is used concomitantly and/or not used concomitantly with solar power. This is rather than using the solar power reflection for initial operating energy. In some embodiments, the enclosed wind and hydropower plant comprises a platform array responsive to solar energy. In some embodiments, the enclosed wind and hydropower plant further comprise of a platform array responsive to solar energy radiation. Other embodiments herein describe apparatus configured for producing renewable electrical energy.

The foregoing and/or other objects and advantages would appear from the description to follow. Reference is made to the accompanying drawing, which forms a part hereof, and in which is shown by way of illustration specific embodiments in which the embodiments may be practiced. These embodiments being described in sufficient detail to enable those skilled in the art to practice the teachings, and it is to be understood that other embodiments may be utilized and that further structural changes may be made without departing from the scope of the teachings. The detailed description is not to be taken in a limiting capacity, and the scope of the present embodiments is best defined by the appended claims.

Referencing the drawings, wherein reference numerals designate identical or corresponding parts throughout the several views, example embodiments of the present patent application are hereafter described. The numbers refer to elements of some embodiments of the disclosure throughout. As used herein, the terms “and/or” and “at least one of” include any and all combinations of one or more of the associated listed items.

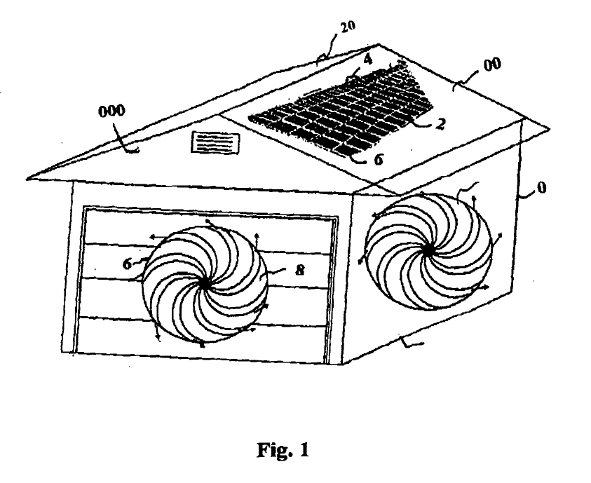

Referring to FIG. 1 is seen an exemplary embodiment of a building structure 20 comprising a vertical member 0, a horizontal member 00, and an angular member 000. The vertical members 0 may comprise of the side walls of the building structure 20. The horizontal members 00 may comprise of the top roof and the floor of the building structure 20. The angular members 000 may comprise of both the vertical and the horizontal members and/or in any configuration that would be angular in structure. A wind generating device is disposed at the roof. The wind generating device comprises a ventilation apparatus 100, being configured for accelerating the inflow of wind into the interior 113 of the building structure 20. The members 0, 00,000, may comprise of at least an opening 2 and 6, being configured for the entrance 4 of the wind and for the exit 8 of the wind.

An objective of disclosed embodiments is to reduce the cost of energy so that wind turbine applications can compete with traditional energy sources, providing a clean, renewable alternative for our nation's energy needs while strengthening our national economic security. Further objective of disclosed embodiments comprises developing cost-effective, high performance wind turbine technology that would compete in global energy markets through innovative design to refine advanced wind turbine plants. Certain embodiments provide renewable energy source which is steady, most reliable, and affordable. Some embodiments provide the most cost-efficient energy source for the market, addressing the growing demand for green electricity worldwide. The turbine cost would drop and the increased supply of green electricity to the grid would be expedited through the application of disclosed embodiments. Disclosed embodiments further address technological challenges arising from wind turbine designers and wide range of technical responses, machine configuration, operational parameters, controls, and power conversion techniques. Embodiments provide apparatus for generating operating wind for the enclosed wind turbine assembly to enable converting mechanical torque into electrical energy. Embodiments provide apparatus for an enclosed wind power plant to generate flow pressure and effectively extract power from the wind turbines, while expanding the lifespan of the plant by making the wind turbines cost effective.

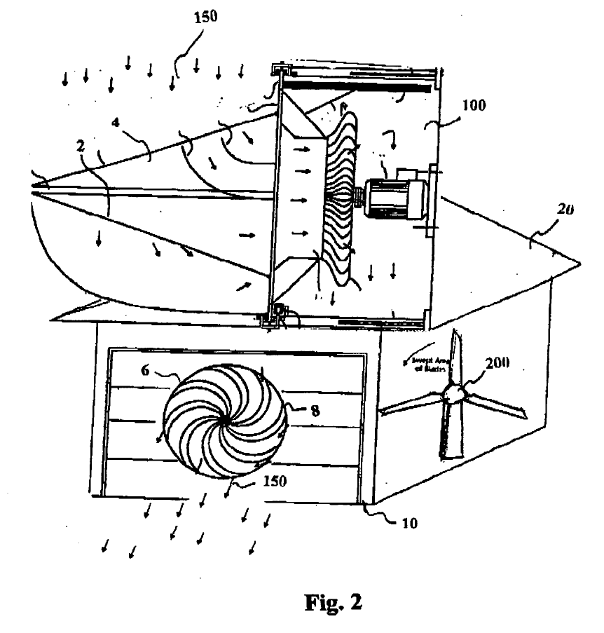

Referring to FIG. 2 is seen an embodiments of the enclosed wind turbine plant 10. Disclosed embodiments can yield economic gains and provide energy security. Disclosed embodiments further provide apparatus comprising of installation of at least a turbine assembly 200 inside a building 20 to generate renewable electrical energy. Embodiments provide at least a method for supplying propellant-wind 150 for the efficient operation of the turbine assembly 200. At least one method herein disclosed comprises at least an apparatus configured for accelerating outside airflow 150 into the building structure 20. The building structure 20 provides at least an entrance channel 2, and an exit channel 8 for the airflow 150, whereby pressure force can be created there-between to propel the blades of the turbine assembly 200. Disclosed embodiments provide innovative cost effective methods and systems for improving energy efficiency at a larger scale, and can have wind turbine plants compete with conventional energy plants to gain more secured energy independence. Certain embodiments of the disclosure comprise at least a ventilation apparatus 100, at least a turbine assembly 200, and at least a building structure 20. The building structure 20 comprises at least a controllable opening 2 at the top 4, and at least a controllable opening 6 at the side 8 through which wind enters and leaves the building structure 20. The wind and hydropower plant 10 is configured for producing renewable electric energy without consumption of fuel oil resources. Yet, other embodiments of the disclosure comprise a wind and hydropower plant 10 that creates no pollution or greenhouse gas emission, and is independent of ocean pressure and/or wind conditions.

Embodiments provide apparatus for extracting proportionate amount of the pressure and directing controllable amount of the wind to operate enclosed wind turbines. Further embodiments of the disclosure comprise apparatus being configured for adjusting to operational thermal conditions suitable for the efficient operation of the enclosed turbine assemblies for the wind and hydropower plant. Embodiments further provide devices for generating wind even when there is wind to the external environment of the plant. The enclosed wind and hydropower plant further comprises a wind turbine plant being configured to generate electricity by converting the kinetic energy of the extracted wind into mechanical energy.

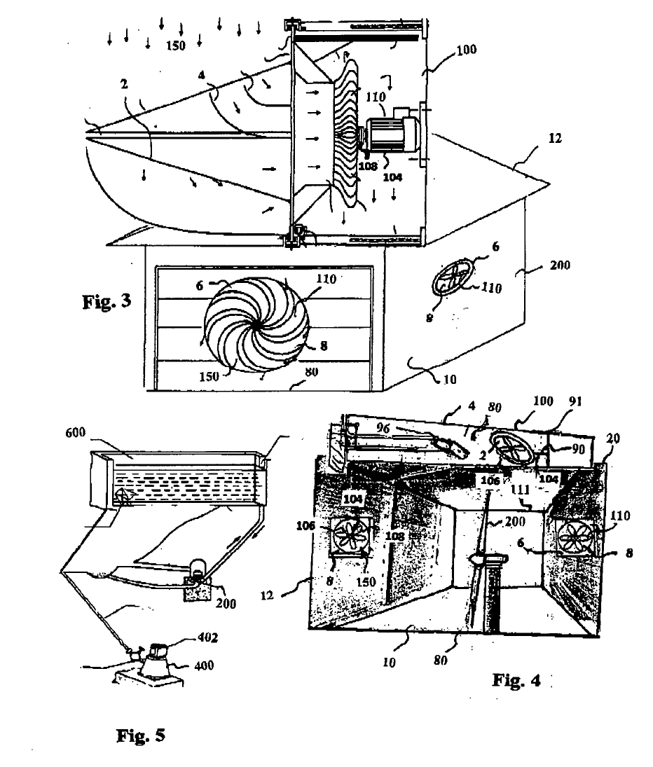

Referring to FIG. 3 is seen an exemplary embodiments of the wind and hydropower plant 12. Disclosed embodiments would produce electrical energy at a lower cost. Disclosed embodiments provide cleaner wind and hydropower plant 12, a domestically produced renewable energy resource that can contribute to our nation's security, improve our environmental quality, and stimulates economic development without destroying the environmental habitats. Disclosed embodiments can be incorporated in existing warehouses that can be easily transformed into a power plant, and may be installed through the embodied methods without any additional aids provided. Disclosed embodiments further include one or more ventilation apparatus 100 operatively configured with fans 110 for generating wind power to operate the turbine assemblies 200 inside the building structure 20 for the enclosed wind energy power plant 12. The wind energy power plant 12 is being configured for generating renewable electrical energy without the conventional wind energy methods.

Disclosed embodiments comprise ventilation apparatus 100 for generating air/wind 150 without a conventional wind flow. Disclosed embodiments provide patterns for openings to enable air/wind 150 passages. Disclosed embodiments further comprise at least a fan assembly 110 disposed on the top 4 of the building 20, and may be disposed on the side exit channel 8 of the building 20. The fan assembly 110 further comprises a system for moving ambient outside air/wind 150 into a wind energy plant 12 or similar storage area to deliver wind and hydropower that can be needed for the operation of advanced wind and hydropower plant 10.

Disclosed embodiments further provide advanced wind turbine technology to address environmental impacts, such as erosions, the killing of births and bats clue to collision with the turbine blades. Visual impact can be eliminated with disclosed embodiments. Shadow flicker and touristic views can be eliminated with disclosed embodiments. There is current opposition to exposable wind farms because of the arising perception that the further development of these farms would spoil the view that habitants are used to. Wind farm applications can experience significant change with the application of disclosed embodiments. The effect of renewable energy efficiency would be symbols of a better, less polluted future resulting from disclosed embodiments. Although the visual effect of wind farms is a historic subjective issue, the criticisms made about exposable wind energy today are vital for improved solutions to be enabled to credit wind mill technology without further creating any worries to local communities.

Referring to FIG. 4 is seen an exemplary embodiment of the building structure 20. Disclosure embodiments provide ventilation apparatus 100 operatively configured with at least one electrically driven fan assembly 110 installed on the upper part of a building 20 and/or at the door 80 of the building 20. A control means 96 is communicatively connected to at least one fan assembly 110 comprises a motor 104 and a fan 108. The fan 108 is connected to the motor 104 through at least a shaft 106. A power cord 90 can be extended from the at least one fan assembly 110 to a fixed source of power 111. The fixed source of power 111 can be from at least a renewable energy source for supplying at least the initial operating energy for the plants' ventilation apparatus 100. The operation of the turbine assembly 200 is responsive to the wind power being created by the ventilation apparatus 100. The turbine assembly 200 is configured to covert the wind power into mechanical energy. Disclosed embodiments provide method and systems for an enclosed wind power plant to generate wind power and effectively empower the wind turbine assembly 200.

Disclosed embodiments provide innovative methods and systems, and can expand the lifespan of wind turbines and could make wind turbine applications more cost effective. There is a force-exerting spring means 91 exerting a continuous tension force on the power cord 90 from the location of the fixed source of power 111 to keep the power cord 90 sufficiently taut by exertion of the tension force so that the power cord 90 has substantially no slack. The initial power source 111 comprises at least one of: a battery means, a solar power 700, or a secondary wind turbine assembly. The spring means 91 for the power cord 90 is configured for eliminating substantially all of the slack in the power cord and does not form any intermediate loop or loops when the wind energy plant door 80 is being opened or being closed, keeping the power cord 90 safe from accidental harm as well as keeping it from becoming a hazard for the wind energy plant door 80.

The Wind and Hydropower plant, in some embodiments, relates to enclosed apparatus for generating abundance of renewable energy without creating any environmental impact. Disclosed embodiments provide environmentally friendly methods. Further embodiments of the disclosure comprise a plant that creates no pollution in the air, and that generates no chemical. The wind and hydropower plan comprises a device for extracting proportionate amount of the environmental pressure into the enclosed space of the building structure. Disclosed embodiments provide methods for generating controllable pressure into the enclosed space when there is no environmental pressure. The device further includes a ventilation apparatus configured for generating wind for the operation of a turbine assembly. Disclosed embodiments further provide apparatus comprising at least high pressure water pump for generating pressure water flow for the hydropower plant. The wind and hydropower plant is configured for generating renewable electrical energy. The plant is configured to produce reliable domestic/industrial energy and relies on the controlled air through the ventilation apparatus and the pumped water from the high pressure water pump to generate renewable electrical energy. Further aspects of embodiments include producing renewable electrical energy on demand through a continuous controllable water and/or wind flow. Certain embodiments of the disclosure comprise enhanced transmission infrastructure for increasing U.S. renewable energy capacity through enclosed wind turbine applications. The application of disclosed embodiments would not be subjected to permitting land requirements because the embodiments are streamlined for a contained environmental friendly infrastructure to enhance reliability and operability of the enclosed wind plant. Some embodiments of the disclosure further comprise advanced development for wind turbine applications to speed the commercialization of wind energy as a reliable infrastructure for national resource of renewable energy.

Certain disclosures of embodiments provide advanced methods to maximize net impact on wind turbine applications and to reduce the overall cost of producing renewable energy through performance enhancement and reliability. The advanced methods further comprising methods for making factors such as maintenance, refurbishment, replacement, and recycling inspection procedures easier and cost effective. Some embodiments provide methods for wind plant application that is appropriate for wind plant operation as a unique solution for ongoing wind energy problems. Further objective of disclosed embodiments comprise improved and reliable methods for operating wind plants. Other objectives of disclosed embodiments comprise method of operating a wind plan with enhanced economic viability and predictive turbine assembly condition monitoring. Further aspects of the predictive monitoring include blades, gearboxes, towers, and generators. Yet, some disclosure of embodiments presents at least a model for predicting real-time performance and for monitoring component failure. Still, certain objectives of disclosed embodiments include reducing unscheduled outages and presenting advanced methods of monitoring failures and scheduling maintenance needs before problems occur. Yet some embodiments of the disclosure provide methods for withstanding extreme environments and environmental conditions, such as high temperatures, high humidity, extreme cold, corrosive offshore environments, high speed wind and dust. Yet, certain objective of disclosed embodiments provides methods for integrating wind turbine applications into total controllable wind for wind plant applications.

Referring to FIG. 5 is seen an exemplary embodiment of a dam 600. Certain embodiments of the hydropower device comprise regenerative dam 600. Disclosed embodiments provide the regenerative dam 600 being pump operated. Disclosed embodiments comprise at least a mechanical pump 400 operatively configured to provide fluid flow for the operation of a turbine assembly 200. Embodiments provide methods and systems to overcome environmental issues. Disclosed embodiments further provide methods and systems for providing fluid for enclosed low cost wind and hydropower plant configured for generating electric power without any consumption of fuel oil resources and for creating pollution, or any greenhouse gas emission. Certain embodiments of the disclosure include wind and hydropower plant 10 being independently operable of wind and/or water pressure conditions. Disclosed embodiments include at least a pump assembly 402, which can be positioned at the top of one or more stacks of fluid for generating fluid pressure to propel a turbine assembly for a hydropower plant, and for increasing flow rate of at least controllable intervals.

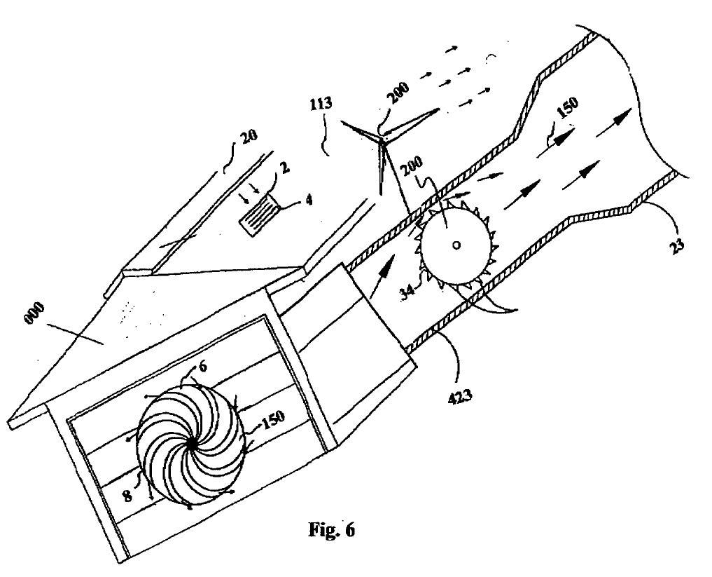

Referring to FIG. 6 is seen similar exemplary embodiments of the wind and hydropower plant 12. More particularly, disclosed embodiments further comprise a tunnel 23 operatively configured for flow-force application. Embodiments provide fluid comprising air/wind 130 and/or water, which could be directed through a tunnel 23. The wind energy plant 12 comprises turbine assemblies 200 being responsive to the fluid flow pressure. Embodiments provide the fluid flow pressure at a controllable temperature and can be configured for accelerating the cooler outside air into the tunnel of the wind energy plant. Disclosed embodiments provide accelerated cooler outside air/wind 150 to cause the operation of the turbine assembly 200. Certain embodiments of the fluid flow inside the tunnel 23 comprise water pressure 423 rotating a wheel/blade 34. Disclosed embodiments further provide methods and systems configured to cause the hotter inside air to be forced out of the wind energy plant interior 113 through the exit channels 8. Certain embodiments of the disclosure comprise pushing the hot air out of the wind energy plant 12, and pulling the cooler ambient outside air/wind 150 in to propel the turbine assemblies 200. Disclosed embodiments further provide methods and systems of operation that can be reversible depending on the environmental condition.

Disclosed embodiments comprise an enclosed wind plan method of using a ventilation apparatus 100 to provide wind 150 for a turbine assembly 200. Disclosed embodiments provide environmentally friendly methods and system that would not cause harm to the inhabitants. Embodiments further provide less saturating methods and system being operable in a confined space. Further disclosure of embodiments includes controllable wind and temperature conditions that provide efficient and effective methods of generating renewable electrical energy. Disclosed embodiments provide methods of preventing habitant destructions, seasonal wind, geological congestions, historical view obstructions, as well as the lack of desire for environmental safety.

The disclosed wind and hydropower plant comprises apparatus enclosed in a building structure operatively configured for providing the necessary air/wind that is needed to propel a wind turbine assembly. A mechanical pump is further provided and operatively configured for providing hydropower to the hydropower section of the plant. The wind and hydropower plant is configured for producing renewable electrical energy without consumption of fuel oil resources. Disclosed embodiments can produce renewable electrical energy without creating any pollution or any greenhouse gas. Disclosed embodiments are independent of conventional wind plant application and protect against environmental conditions, such as environmental emergencies. Yet, disclosed embodiments provide renewable electrical energy that is cleaner, regenerative, and at a lower cost.

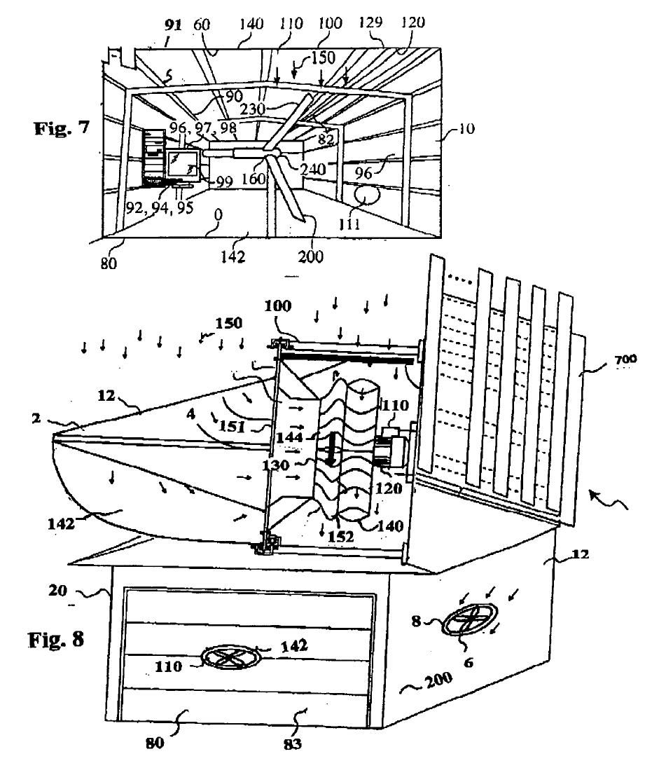

Referring to FIG. 7 is seen an exemplary embodiment of the disclosure. Certain features of disclosed embodiments include applications in congested environmental/city. In some embodiments provide methods to control the physical location of the part of the electrical power cord 90 that can be extended from the fixed location of the electrical power source 00, 111 to the fan motor 120. Embodiments provide the fan motor 120 being configured for the operation of the ventilation apparatus 100. Disclosed embodiments comprise the motor 120, which can be disposed on the wind energy plant door 80 for the building structure 20. In the later embodiments, the motor 120 can be moved with the wind energy plant door 80 without interfering with the opening position 82 or closing position 142. Embodiments provide a fan assembly 110 operatively connected to the motor 120. The fan assembly 110 and the motor 120 can be mounted on the wind energy plant door 80 and/or can be mounted at the top roof/ceiling 60 of the building structure 20. The power cord 90 is extended from a fixed connection with the power source 111 to the fan motor 120. Further disclosure of disclosed embodiments provide methods to eliminate the cord installation in the wind energy plant door 80 which may be hanging down or possibly being caught between two of the wind energy plant door hinged sections. The wind energy plant door 80 is configured for movement and for the operation of the ventilation apparatus 100. The ventilation apparatus 100 can be moved to the vertically-closed position and/or to the horizontally opened position.

Disclosure embodiments can improve environmental quality and can contribute to our national security. Still, disclosed embodiments can stimulate economic development. Disclosed embodiments can not destroy environmental habitats and would not cause any harm to the inhabitants. Still, thither disclosure of embodiments is configured to provide a less saturating power plant. Yet, embodiments can be operable in a confined space and can further prevent geological congestions. Certain disclosures of embodiments can prevent historical view obstructions. Yet, other disclosed embodiments can protect environmental and city needs. Still, some disclosed embodiments can prevent turbine assembly operations against turbulence. Other disclosed embodiments can protect turbine operations against extreme wind.

Embodiments provide large energy production for industrial and commercial applications through the use of concentrated dam and enclosed wind turbine assembly. Embodiments further provide effective concentrated dam and effective turbine assembly operation for energy production that can be appreciated because of the less devoted amount of water used to produce the renewable electrical energy. Water is an important but overlooked issue of renewable energy devices can affect the world's demand of water. Disclosed embodiments provide apparatus for producing effective renewable energy.

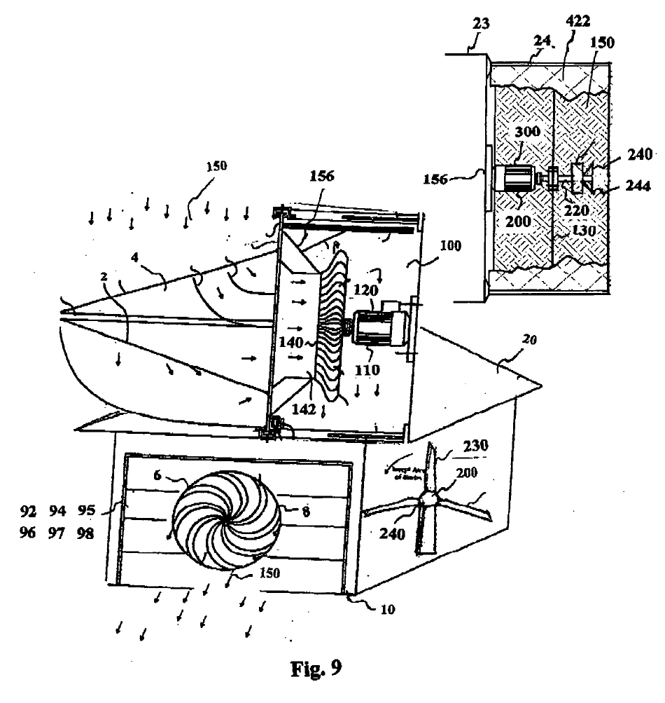

Referring to FIG. 8 is seen further exemplary embodiment of the disclosure. Disclosed embodiments provide apparatus operatively configured to produce electricity at cost effective rates in an environmentally friendly manner. Disclosed embodiments provide apparatus configured for enclosed wind energy plant applications. Embodiments provide methods and systems that further depart from conventional wind energy plant applications. Further disclosure of embodiments provides methods and systems for preventing plant operation environmental emergencies. Embodiments provide methods and systems operatively configured to prevent the exposure of turbine operations against extreme wind velocity and turbulence. Certain disclosed embodiments provide turbine assembly 200, which can be enclosed inside building structure 20. Certain embodiments provide at least a device for generating/directing wind into the building structure 20. The device comprises a ventilation apparatus 100 for the enclosed wind energy plant 12. The installation can also be achieved in a building structure 20 that could be located in heavily populated major cities. Some embodiments herein disclosed comprise ventilation apparatus 100 operatively configured for supplying accelerated air/wind 150 for the turbine assembly 200 operation in the enclosed wind energy plant 12. The ventilation apparatus 100 can be configured with air scoop assembly 140 which can be hoisted above a vertical/horizontal axis. Disclosed embodiments provide the air scoop assembly 140 configured for utilizing the prevailing air/wind 150 and direct the maximum airflow 150 to propel the turbine assembly 200 at maximum regenerative wind velocity head pressure.

The ventilation apparatus 100 comprise a motor 120 being configured with a fan 110 to direct the airflow 150. The fan assembly 110 is configured to operate the air intake port 151. The air intake port is responsive to access door 144, being open to allow airflow 150. The air flow can be directed downwardly in communication with the turbine assembly 200. Certain embodiments of the disclosure further comprise the opening 2 comprising the airflow entrance 4, and the opening 6 comprising the airflow exit 8. The airflow exit structure may be disposed at the walls or at the door 80. The velocity head pressure can enter the building structure 20 through the access door 144 and out through the exit structure 8. The pressure difference between the entrance 4 and the exit 8 determines the speed at which the turbine would operate. The airflow may be distributed uniformly and downwardly for operation of the turbine assembly 200. A solar power 700 is configured with the plant 12, to supply the initial operating energy for the initial operation of the ventilation apparatus 100.

Further disclosure of embodiments include an enclosed wind and hydropower plant configured for producing renewable electrical energy without consumption of fuel oil resources. Some benefits of disclosed embodiments include:
a) Creates no pollution
b) Creates no greenhouse gas
c) Produces electrical energy at lower cost
1. According to embodiments, energy is independent produced without the effect of natural wind flow and environmental condition
2. Energy is cleaner and regenerative
3. Disclosed embodiments would contribute to national security
4. Disclosed embodiments would contribute to improved environmental quality
5. Disclosed embodiments would stimulate economic development
6. Disclosed embodiments would not destroy environmental habitats
7. Disclosed embodiments would not cause harm to the inhabitants
8. Disclosed embodiments is less saturating
9. Disclosed embodiments is operable in confined spaces
10. Disclosed embodiment would prevent against geological congestions
11. Disclosed embodiments would prevent against historical view obstructions
12. Disclosed embodiments protects environmental and city needs
13. Disclosed embodiment is protected against turbulences
14. Disclosed embodiments are protected against extreme wind conditions
15. Disclosed embodiments is aimed at strengthening market capacity for sustained commercial operation of industrial/domestic energy enterprise
16. Disclosed embodiments comprise climate-friendly solutions for meeting industrial/domestic energy needs in a manner that is committed to sustainable market development.

Referring to FIG. 9 is seen further exemplary embodiments of the disclosure of tunnel. Disclosed embodiments provide a tunnel 23 comprising a flow tube assembly 24 being disposed with the turbine assembly 200. The turbine assembly is being configured with rotor assembly 240. In some embodiments of the disclosure, the air/wind 150 from the flow tube assembly 24 can be routed in a radial direction to propel the turbine rotor assembly 240. Certain embodiments of the turbine assembly 200 operatively connected to a generator assembly 300. Further disclosed embodiments provide the ventilation apparatus 100, which can be positioned to optimally supply airflow 150 for the operation of turbine assembly 200. In other embodiments, the ventilation apparatus 100 comprise a moment arm 142 communicatively connected to the air scoop assembly 140. Certain embodiments of the disclosure include stabilizing vanes assembly 156 in communication with the air scoop assembly 140 being configured to increase the inflow rate of air/wind 150 and to effectively and efficiently operate the turbine assembly 200.

Certain embodiments of the disclosure comprise controls 92, 94, 95, 96, 97, and 98. The control 92 for disclosed embodiments is configured with at least a manual switch 97. Switch 97 is being operatively configured for On/Off operations responsive to safe operative conditions of the ventilation apparatus 100. Certain embodiments of the disclosure further comprise one or more controls 92, 94, 95, 96, 97, and 98 each configured for sensing one or more different conditions within the enclosed wind energy plant 12. Embodiments provide the controls 92, 94, 95, 96, 97, and 98 further responsive to thermal conditions for controlling the wind and hydropower plant 10. Further embodiments provide methods and systems for controlling the enclosed wind and hydropower plant 12, including a thermostat comprising thermal control 95 being configured for sensing the temperature within the building structure 20 for the wind energy plant 12. Some embodiments provide the thermal control 95 further comprising methods and systems for sensing the temperature of the exterior ambient air that might be pulled into the wind energy plant 12 and/or wind and hydropower plant 10. Some embodiments provide methods and systems for adjusting the temperature within the building structure to enable efficient operation of the plant 12. Certain embodiments provide plurality fan motors 120 that can be energized when any one or more sensed conditions reaches a predetermined level. The thermal control 95 may be subjected to the sensing of a controllable temperature and/or current for the operation of wind energy plant 12.

Other embodiments of the disclosure include at least a safety manual control switch 97 being configured for allowing stopping the fan motors 120 independently or for preventing the fan motor 120 from starting. Some embodiments of the disclosure include means for preventing back pressure to the turbine wheels/blades assembly 230. In other embodiments provide methods and systems of generating renewable energy, further include exit ports 250. Certain embodiments of the disclosure include methods and systems for providing additional enhanced power generation for the enclosed wind energy plant 12. Disclosed embodiments provide turbine assembly 200 being configured with over-speed limiting apparatus for controlling the speed or velocity of the supplied air/wind 150. Further embodiments of the disclosure comprise the rotor 240. The rotor 240 further comprises at least air foiled wheels/blades assembly 230 and/or a combination of air foil blade 230 and bucket type turbine blade 244 each operatively configured to provide the operation of the turbine assembly 200 from both the highest and lowest wind speeds. Some embodiments include a bucket or impulse blades 244 being configured for maximum torque. The turbine assembly is configured for enclosed applications for at least the minimum/maximum possible wind speeds. Certain embodiments as disclosed comprise the air foil design being configured to provide optimum overall wind performance and torque for operation of the wind energy plant 12 at higher supplied wind speeds.

Further embodiments as disclosed in FIG. 8 provide apparatus for supplying the interior part of the building structure 20 for the wind and hydropower plant 10 with sufficient operating air/wind 150. Embodiments further provide apparatus being configured for adjusting to the required operating temperature for the wind energy plant 12 and/or the wind and hydropower plant 10. Some embodiments of the disclosure provide apparatus being configured for increasing the inflow wind pressure and for directing the pressurized wind to energy generating mediums. The energy generating mediums comprise at least substrate-fiber configuration for generating electrical energy. Disclosed embodiments provide methods and systems of operations, including operation of the wind and hydropower plant 10 with the wind energy plant door 80 being opened or closed, and being responsive to outside air. Other embodiments provide methods and systems for allowing the circulation of the outside air into the wind energy plant 12 and for operating the turbine assembly 200 and pushing the inside air out. Still other embodiments provide the supplied air/wind 150 being circulated within the wind energy plant 12. Certain embodiments provide the ventilation apparatus 100 being operatively configured with apparatus for pushing or pulling the air from the top of the wind energy plant downwardly or upwardly. The air/wind 150 movements inside the enclosed wind energy plant 12 can propel the wheels/blades assembly 230 of the turbine assembly 200.

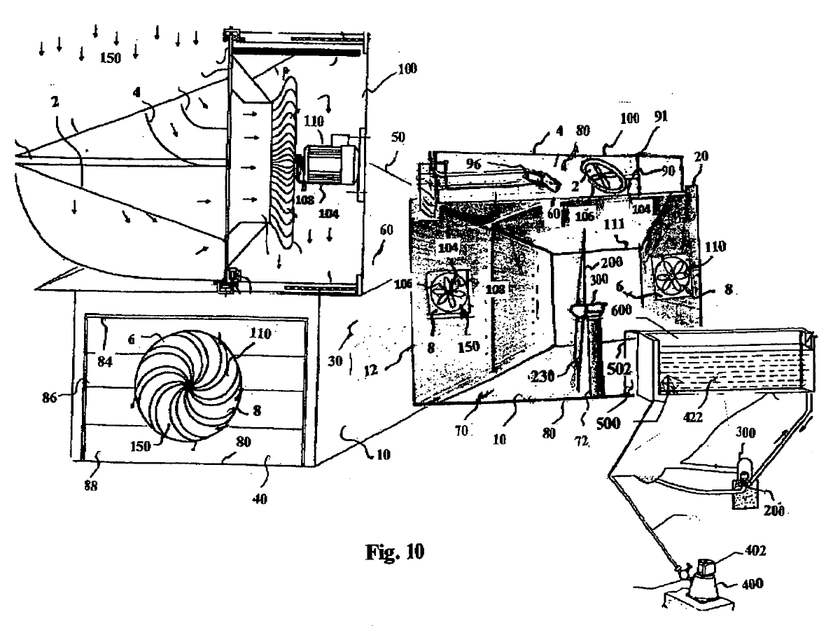

Referring to FIG. 10 is seen further exemplary embodiment of the ventilation apparatus and the hydropower apparatus for the plant. Embodiments provide apparatus comprising methods and systems for operating an enclosed wind and hydropower plant 10. The apparatus is configured for generating renewable electrical energy. Disclosed embodiments comprise a building structure 20 consisting of at least a wind turbine assembly 200, and/or at least a water turbine assembly 200. At least one turbine assembly is being configured for converting fluid pressure into electrical energy. Certain embodiments of the disclosure provide methods and systems for generating renewable electrical energy. The generated energy can be deployed for the operation of at least a mechanical pump device assembly 400, and at least a compressed air device assembly 500. At least one or a combination of both device assemblies 400, 500 being configured for creating compressed air and/or hydropower. Certain embodiments of the hydropower device assembly 400 comprise regenerative dam 600. Some embodiments provide methods and systems for operating a regenerative dam 600. The regenerative dam 600 could be pump operated. Still, certain embodiments of the disclosure comprise a ventilation apparatus comprising at least one or both devices 100, 400 operatively configured for providing fluid suctions. Disclosed embodiments further provide methods and systems to overcome environmental issues commonly found in conventional wind and hydropower plant. Conventional wind and hydropower plants include exposable wind turbines and other massive dams. Embodiments provide enclosed low cost wind and hydropower plant for generating renewable electric power without consumption of fuel oil resources and/or creating pollution, or creating greenhouse gas emission. Certain embodiments of the disclosure further include wind and hydropower plant 10 being configured to be operated independently and/or to be operated in their combinations. Additionally, embodiments provide apparatus comprising at least one of: a ventilation apparatus 100, and a hydropower device assembly 400. At least one device could be positioned at the top of one or more stacks for generating fluid pressure for a power plant, and for increasing flow rate of at least the fluid.

Disclosed embodiments comprises a non conventional wind and hydropower plant 10 configured with devices for supplying air/wind 150 and/or for controlling sufficient interior environmental conditions, including temperature conditions of a building structure 20. Disclosed embodiments further consist of a regenerative wind and hydropower plant 10. Certain embodiments of the disclosure comprise apparatus for supplying the wind and hydropower plant 10 with fluid 422 to enable operations of the wind and hydropower turbine assemblies 200. Disclosed embodiments further comprise a ventilation apparatus 100 operatively configured for supplying operational air/wind 150 to at least the turbine assembly 200 for an enclosed wind energy plant 12. Other embodiments of the disclosure comprise the turbine assembly 200 being responsive to enclosed regenerative pressure. Disclosed embodiments provide methods and systems for producing reliable, effective and efficient renewable electrical energy. Embodiments are configured for a wind and hydropower plant operation, and are being enclosed in a building structure 20. Embodiments provide useful applications for generating renewable electrical energy to overcome environmental problems. Disclosed embodiments further provide methods and systems for generating renewable electrical energy, including the protections of environmental inhabitants. Disclosed embodiments provide innovative methods and systems that can be very useful for renewable energy plant operations even without the free-movement of natural wind or the creation of conventional dams.

In some embodiments of the disclosure, the ventilation apparatus 100 is horizontally mounted. In other embodiments of the disclosure, the ventilation apparatus 100 is vertically mounted. Certain embodiments of the disclosure may include angular mount. Embodiments provide wind generating apparatus comprising door and/or roof mounted ventilation apparatus 100 for supplying the wind energy plant 12 with propellants for enabling the operation of turbine assembly 200. The turbine assembly 200 is being configured for generating renewable electrical energy. Certain embodiments further include a roof/ceiling 60 mount ventilation apparatus 100 for supplying the wind energy plant 12 with propellant for operating turbine assembly 200, being configured for generating renewable electrical energy. The wind energy plant 12 comprises a ventilation apparatus 100. In certain embodiments, the ventilation apparatus is door 80 mounted. In some embodiments, the door 80 may be a solid door and or a tilt-able door 80. Some embodiments of the disclosure include tilting from the vertically closed/opened position for supplying operating air/wind 150 for the wind energy plant 12.

Certain embodiments of the disclosure further provide horizontally mounted apparatus in closed/opened position for supplying operating air/wind 150 for the wind energy plant 12. Yet, disclosed embodiments further include compressed air device assembly 500. The compressed air device assembly 500 includes air compressor assembly 502, air dryer 506, and air supply lines 508, being further configured for supplying the turbine assembly 200 with a supplemental proportionate operational air force to provide rotation of the turbine wheels/blades assembly 230. The rotation of the turbine wheels/blade assembly 230 is being converted into mechanical energy. The mechanical energy is then converted into renewable electrical energy by a generator assembly 300.

The enclosed wind and hydropower plant 12 comprises a building structure 20 enclosed with wind turbine assemblies 200 being responsive to wind generated by at least a ventilation apparatus 100. The ventilation apparatus 100 is provided to operate the wind energy plant 12. The wind energy plant 12 is enclosed in the building structure 20, comprising walls 30, 40, 30, 60 and 70. The walls comprise the side walls 30, the front walls 40, the back walls 50, and the roof/ceiling walls 60. Disclosed embodiments provide the ventilation apparatus 100, which may be disposed on at least one wall. Other embodiments of the disclosure comprise the turbine assembly 200 being secured by at least a fastener 72 on the floor 70 of the enclosed wind energy plant 12. The wind energy plant door 80 comprises of opening 142 in the front walls 40. Certain embodiments of the wind energy plant door 80 include panels 84, 86, and 88, such as an upper panel 84, at least a medium panel 86, and a lower panel 88.

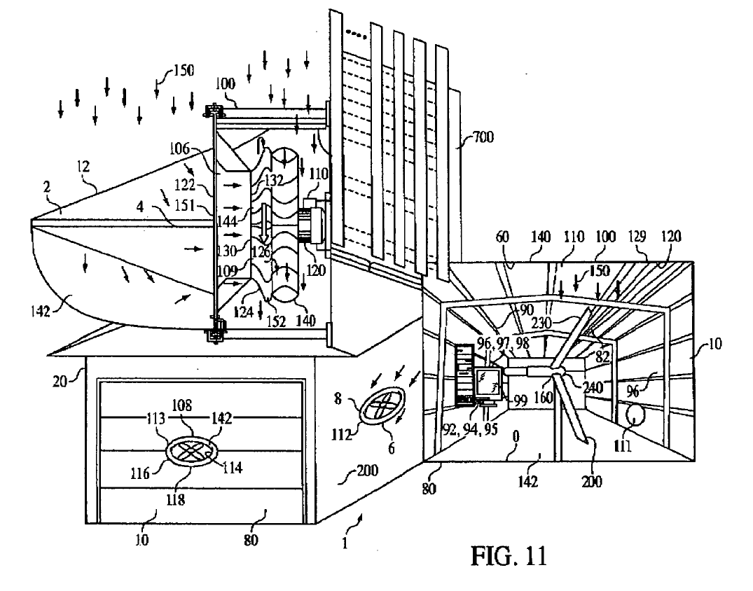

Referring to FIG. 11 is seen further exemplary embodiment of the building structure. Some embodiments of the disclosure further include electrical cord 90 connecting the power source 111 to at least a control panel 92, which include a wall switch 94. The wall switch 94 further provide operations to activate the wind energy plant door 80 in an opened or closed position, and also provide operations for controlling the ventilation apparatus 100. The ventilation apparatus 100 can be disposed at the roof 60 and/or at door 80. Further embodiments of the disclosure comprise the control panel 92, 94, 95, 96, 97, and 98, comprising a computer apparatus 99. The computer apparatus 99 communicatively configured with the ventilation apparatus 100. The ventilation apparatus 100 is operatively configured with at least a fan motor 120. The fan motor 120 is communicatively connected to at least a fan assembly 110. Certain embodiments thither include the fan motor 120 operatively configured for providing rotation to the fan assembly 110 in one direction to cause air/wind 150 to flow through an opening 142 and cause the turbine wheels/blades assembly 230 to be in operation. The wind flow 150 into the building 20 enables rotational motion of the wheels/blades 230 that is being transferred into mechanical energy. Certain embodiments of the disclosure comprise a generator assembly 300 communicatively connected to the turbine assembly 200 for converting the mechanical energy into electrical energy. The generator assembly 300 is coupled to the turbine assembly 200. The turbine assembly 200, being in fluid communication with the ventilation apparatus 100.

Other embodiments of the turbine wheels/blades assembly 230 comprise rotor assembly 240 further responsive to the air/wind 150 generated by the ventilation apparatus 100. The ventilation apparatus 100 is responsive to electrical energy for providing operation of the inflow opening mechanism 130. The inflow opening mechanism 130 is provided for supplying the inflow of air/wind 150 to the turbine wheels/blades assembly 230. Disclosed embodiments provide the ventilation apparatus 100, which can be actuated to open/close position to allow the inflow of air/wind 150 and to close the mechanism 130 when the air/wind 150 is not desirable. Certain embodiments of the disclosure provide the ventilation apparatus 100, further comprising apparatus for accelerating the inflow rate of air/wind 150 for peak operation of at least enclosed turbine assembly 200 to generate renewable electrical energy at peak periods. Certain embodiments provide enclosed environment comprising a building structure 20.

Additionally, in open flat terrain, a utility-scale conventional wind plant would require about 60 acres per megawatt of installed capacity and only 5% or less of this area is actually occupied by turbines. The other 95% remains free for other compatible uses such as farming/and/or ranching. Water use can be a significant issue in energy production, particularly in areas where water is scarce, because conventional power plants use large amounts of water for the condensing portion of the thermodynamic cycle. In coal plants, for example, water is used to clean and process fuel. Besides, small amounts of water are used to clean wind turbine rotor blades in arid climates where rainfall does not keep the blades of conventional exposable wind turbines clean. Disclosed embodiments further provide methods and systems for eliminating dust and insect buildup. Disclosed embodiments further provide methods and systems for preventing deformation to the shape of the airfoil and also methods and systems for improving performance. Disclosed embodiments provide methods and systems to extend turbine life. Embodiments further provide apparatus for producing effective and efficient renewable energy. Further disclosure of embodiments provide apparatus for producing renewable electrical energy through enclosed wind turbine plant which preserve further usage of water per unit of electricity produced over the amount of water being used by nuclear energy plants, coal energy plants, and natural gas energy plants.

Certain embodiments further comprise at least a diffuser 170: Disclosed embodiment further comprise the ventilation apparatus 100 operatively configured for supplying controlled flow rate of air/wind 150 for operating an enclosed wind energy plant 12. Certain embodiments further provide the control system comprising at least an automatic controller 92 being operatively configured for providing the control energy for efficient operation of the ventilation apparatus 100. The ventilation apparatus 100 is being configured for supplying the operating air/wind 150 for the enclosed wind energy pant 12. Certain embodiments provide the enclosed wind energy plant 12, and the ventilation apparatus 100, comprising at least a ridge and/or soffit ventilation apparatus 100. The ridge ventilation apparatus 100 and/or a soffit ventilation apparatus 100 being operatively configured for supplying operating air/wind 150 for the wind energy plant 12. Disclosed embodiments provide effective configuration to allow inflow of air/wind 150 through at least soffit vents 102 and out through the ridge vents 104. Embodiments provide protection to the roof/ceiling 60 of the wind energy plant 12 by cooling and drying the inflow of air/wind 150.

Disclosed embodiments provide wall control panels 92, 94, 95, 96, 97, and 98, being operatively configured with the ventilation apparatus 100 and communicatively connected to the air/wind access door 80 for the wind energy plant 12. Certain embodiments of the disclosure further include a transmitter 98 operatively configured for closing the ventilation apparatus 100 for the wind energy plant 12. The transmitter 98 is further configured for minimizing and/or maximizing the flow rate of air/flow 150 to operate the wind energy plant 12. Disclosed embodiments provide methods and systems of operation of at least a control panel and the transmitter 98. The operation control panels and the transmitter provide reversible means configured to reverse the flow direction of the fan assembly to minimize and/or maximize the ventilation apparatus. Other embodiments of the disclosure include a ventilation apparatus 100 being mounted to the side 30 of the wind energy plant 12. Some embodiments of the disclosure further comprise the ventilation apparatus 100 being ducted to the outside 0 of the wind energy plant 12. The duct being supplied with vents without further creating holes in the building 20.

Other embodiments further include the ventilation apparatus 100 being comprise of apparatus for directing outside air/wind 150 into an enclosed environment 20 to operate at least a turbine assembly 200 for the energy plant 12. Embodiments further provide means 112 for carrying the inside air/wind 150 for the wind energy plant 12 to the outside environment 01. The configurations for the energy plant 12 further include the air/wind 150 being controllable from the ventilation apparatus fan assembly 110 through at least a duct 106 to operate the turbine assembly 200 for the wind energy plant 12. Other embodiments of the disclosure include ports 108 and or flap-able ports 109 built into the wind energy plant door 80 and/or walls 40, 50, for allowing air/wind 150 to be forced out of the wind energy plant 12. Certain embodiments of the disclosure further comprise at least a fan assembly 114 being coupled to the ports 108, and 109.

Disclosed embodiments further comprise the fan assembly 114 being configured to exhaust the in flow of air/wind 150 out of the wind energy plant 12. Some embodiments of the fan assembly 114 further include an outer wall 116, configured for cavity and having air inlet 118 formed at its inside end 113, and being exhausted to the outside environment 01. Certain embodiments of the disclosure comprise the air inlet 118 being responsive to the operational air/wind 150. Some embodiments of the ventilation apparatus 100 comprise at least an inner wall 122, being fastened to the outer wall 124, and positioned in the cavity environment 112 for allowing operation of at least a chamber 126. Disclosed embodiments provide a chamber 126 being configured for accelerating the inflow of air/wind 150. In other embodiments, at least a motor 120 is operatively configured with the chamber 126, and operatively connected to means for driving the fan assembly 110. Embodiments further provide a shaft 129. The motor 120 is connected to the fan assembly 110 by at least a shaft means 129. Some embodiments provide coupling 132. The coupling 132 is operatively connected to the chamber 126, and communicatively connecting the ventilation apparatus 100. The ventilation apparatus 100 is configured with shaft 129 and the fan 110.

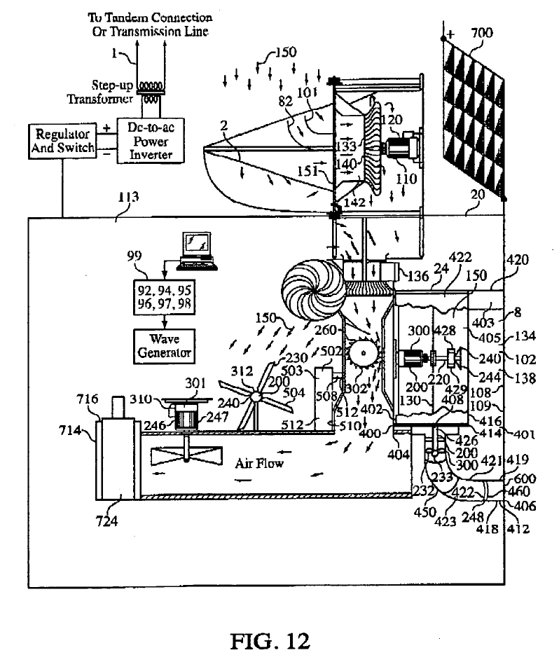

Referring to FIG. 12 is seen further exemplary embodiments of the wind and hydropower plant. The fan assembly 110 includes a fan wheel/blade 133 being configured for controlling the inflow of air/wind 150 to the interior 113 of the building structure 20, for the wind and hydropower energy plant 12. Solar power 700 is provides for supplying initial operating energy for the ventilation apparatus 100 and the pumps. Further embodiments of the disclosure provide the air/wind flow outlet 8, being configured to direct the inside wind pressure outwardly through at least an air/wind band 134 disposed with the wind energy plant 12. Disclosed embodiments provide the ventilation apparatus 100 further comprising the fan assembly 110. The fan assembly 110 comprises wind generating apparatus being configured to propel the turbine assembly 200. Certain embodiments of the disclosure comprise the air/wind 150, being drawn out of the building structure 20 through the exit pot 8 by the fan assembly 110. Some embodiments provide methods and systems for operating a turbine plant inside a building. The building comprises operational configuration for the wind energy plant 12, and include mechanical and/or electronic control elements 92, 94, 95, 96, 97, and 98 comprising a computerized control means 99. Other embodiments of the disclosure may include hoods 136 for supplying the turbine assembly 200 with the operational amount of air/grind 150. Some embodiments provide ports 108, and 109 being further comprise of at least a manifold 138 being responsible for venting inside air/wind 150 outwardly.

Embodiments further provide methods and system for generating renewable electrical energy, further comprising plurality of ventilation apparatus 100 being configured for providing communications to plurality wind turbine assembly 200. At least one ventilation apparatus 100 is being disposed in a building structure 20 being configured to extends centrally, distributive, vertically horizontally/and/or angularly therefrom. Certain embodiments of the disclosure provide air intake assembly 101 comprising intake ports/openings 82 communicatively connected to a central airflow supply 140. The air intake supply 140, being in communication with airflow exit 102 comprising of smaller diameter. Some embodiments of the disclosure provide the air intake assembly 101, being operatively configured to supply air/wind 150 to drive at least a turbine assembly 200. Disclosed embodiments provide the turbine assembly 200 being communicatively connected to a generator assembly 300. The generator assembly 300 comprises apparatus for converting mechanical energy into renewable electrical energy. Disclosed embodiments further provide the generator assembly 300 being communicatively connected to a power storage medium. Certain embodiments provide a power storage medium comprising of transformers and/or grids 001. The power storage medium 001, being operatively configured to further supply the operating power to at least one of a compressed air apparatus 500, a mechanical pump assembly 400, a hydraulic pump assembly 402, and/or fluid pump assembly 404.

Certain embodiments provide generator assembly 300 being configured to provide from 10 kW to 250 MW of rated power. Embodiments provide advanced technology, including permanent magnet generator assembly 310. The permanent magnet generator assembly 310 may comprise at least a gearless design 312 configured to maximize small- to mid-size operation of the wind energy plant 12. Some embodiments provide methods and systems that are highly reliable and could produce renewable electrical energy at low maintenance cost. The generator assembly 300, in certain embodiments, is being further configured for maximum wind energy capture. Other disclosed embodiments provide methods and systems, comprising a directional array of air/wind 150, in communication with the turbine assemblies 200. Each wind turbine assembly 200 comprises a housing 246 operatively configured with blades/wheels 230, being responsive to the inflow of air/wind 150 therethrough. The turbine assembly 200 further comprises ring gear 260 in communication with the generator 302. The generator assembly 302 is operatively configured for converting mechanical energy into electrical energy. The ventilation apparatus 100 comprises means for accelerating the inflow of wind 150 for allowing efficient operation of the turbine assembly 200. Disclosed embodiments further provide methods and systems for maximizing the torque being transferred to the turbine. The rotational energy of the turbine is being converted into renewable electrical energy by the generators 302.

Disclosed embodiments further provide compressed air assembly 500. Certain embodiments comprise at least an air compressor assembly 502. The air compressor assembly 502 further comprises at least a control means 503. The control means 503 may include a control valve 504, at least an air dryer 506, and at least supply lines 508. Certain embodiments of the compressed air assembly 500 comprise a pressure valve 510 operatively connected to a supply port 512. The supply port 512, further comprising means for supplying at least the generated airflow 130 into the building structure 20 for the operation of at least a turbine assembly 200. Some embodiments of the disclosure provide apparatus for generating renewable electrical energy. The controlled airflow 150 is being generated to propel turbine assemblies 200 disposed in the building structure 20 comprising the enclosed wind and hydropower plant 10. In some embodiments, the airflow 150 is being generated by at least an air compressor 502. Other embodiments provide methods and systems for generating the airflow 150. Further comprising at least a ventilation apparatus 100 operatively configured for supplying ground ambient air/wind 150 into the wind energy plant 12. Disclosed embodiments provide the airflow 150 being directed for propelling the wind turbine assembly 200. Further configuration of the air/wind 150 includes flow through an air intake port 151. The flow of air/wing 150 is required for turning a turbine wheels/blades assembly 230, which is being configured with a drive shaft assembly 220. The drive shaft assembly 220 is being communicatively connected to generator assembly 300. Certain embodiments of the disclosure include the pressure control valves 510 operatively connected to the air compressor 502. Other embodiments provide the control valve 510 being configured with at least an automatic controller 514.

The automatic controller 514 is being operatively configured for regulating the airflow rate to the turbine assembly 200. Further embodiments of the disclosure include an enclosed wind energy plant 12, comprising means for generating renewable electrical energy through the rotation of a turbine wheels/blades assembly 230. Disclosed embodiments provide methods and systems for creating mechanical energy. Other embodiments provide the mechanical energy being created from the rotation of the wheels/blades assembly 230. Disclosed embodiments further provide methods and systems for converting mechanical energy into electrical energy. Other embodiments provide the mechanical energy being converted into renewable electrical energy by at least the generator assembly 300. Certain embodiments of the disclosure further comprise the rotation of the wheels/blades assembly 230 being enabled from the controlled flow of air/wind 150 to the wind turbine assembly 200. Certain embodiments of the disclosure further include air/wind 150 flowing from a plurality of ventilation apparatus 100 to operate the enclosed wind energy plant 12. Some embodiments of the disclosure include the wind and hydropower plant 10 comprising a regenerative damn 600. Some embodiments provide the dam 600 being responsive to pump operated pressure 403. Other embodiments provide the dam 600 responsive to drag force 405. Still, other embodiments provide the dam 600 comprising regenerative falling water 406. Yet, some embodiments of the disclosed wind and hydropower plant 10 comprise hydropower energy generating apparatus 408. Certain embodiments of the hydropower energy generating apparatus 408 comprise a land plant 401 consisting of a building structure 20. Still, other embodiments of the hydropower energy generating apparatus 408 further comprise a land based wind and hydropower plant 10, operatively configured with hydro-turbine assembly 200.

Some embodiments of the hydropower energy generating apparatus 408 further comprise apparatus for converting low pressure fluid into high pressure fluid. Certain embodiments of the apparatus for converting low pressure fluid into high pressure fluid include a pump apparatus 412. Some embodiments provide the pump apparatus 412 further comprising a hydro pump assembly 414. Other embodiments provide the hydro pump assembly 414 further comprising a hydraulic pump assembly 402. Yet, other embodiments provide the pump apparatus 408 further comprising water pump assembly 416. Some embodiments of the pump apparatus 408 further comprise at least a mechanical pump assembly 400. Certain embodiments provide the pump apparatus 408 comprising an inlet 418 consisting of at least a suction side, and an outlet 420 consisting of at least a pressure delivery side. Some embodiments provide at least a supply line 419 at the suction side of the pump in communication with at least a fluid 422, such as, as an example, water 423 and/or air 150.

Disclosed embodiments further provide at least a delivery line 421 at the delivery side of the pumps apparatus 408, in communication with at least a turbine assembly 200. The turbine assembly 200 includes a housing 246, operatively configured to receive fluid 422 through an opening 248 comprising wheels/blades assembly 230. Yet, disclosed embodiments further provide the housing 246 further configured with apparatus for converting at least one form of energy into at least another form of energy. Certain embodiments provide at least an apparatus comprising electrical generator assembly 300 disposed in the housing structure 246. The electrical generator assembly 300 is being responsive to at least a mechanical assembly rotation 220. The electrical generator assembly 300 can be communicatively connected to wheels/blades assembly 230 having an opening 248 configured for receiving fluid flow 422. The wheels/blades assembly 230 can be operatively connected to an axle structure comprising drive shaft assembly 220 configured for converting kinetic energy into mechanical energy.

Certain embodiments of the housing 246 further comprise an electrical generator 302: at least a turbine assembly 200 located in the housing 246 in fluid communication with the opening 248, through at least an inlet channel 418. At least the fluid inlet channel 418 comprises an entrance, and at least fluid exit channel 420 comprising an outlet. The channels 418, 420 comprise means through which at least kinetic energy is converted into at least a form of energy. Disclosed embodiments provide methods and systems for operating a hydropower plant on still waters. Other embodiments of the disclosure further comprise the inlet and the outlet fluid line 418, 420 comprising the fluid line. Some embodiments provide the fluid line 418, 420 comprising at least a pipe 450. Certain embodiments provide the pipes 450 comprising apparatus for controlling flow rate of fluid 422. Some embodiments provide apparatus comprising at least a flow valve 460. Still, certain embodiments provide the pipe 450 being responsive to outlet pressure. Certain embodiments of the disclosure further comprise the outlet pressure being greater than the inlet pressure. Some embodiments provide the outlet pressure communicatively connected to the wheels/blades assembly 230.

Disclosed embodiments provide the wheels/blades assembly 230 being communicatively connected to the turbine generator assembly 300. The turbine assembly 200 being responsive to the energy due to the fluid force. Disclosed embodiments further provide the generator assembly 300 being responsive to the mechanical energy created by the turbine assembly 200. The generator assembly 300 further comprises apparatus for converting the mechanical energy into renewable electrical energy. The housing 246 further comprises a turbine housing portion 247, and the generator housing portion 301. Embodiments provide the turbine assembly 200 being located in the turbine housing portion 247, and the generator assembly being located in the generator housing portion 301. Disclosed embodiments further provide the inlet channel 418 being configured to supply at least fluid to a pump apparatus 412. The pump apparatus 412 is being configured to increase the velocity of fluid flow. The turbine assembly is thither configured with wheels/blades 230, being further responsive to the increased velocity of fluid flow. The fluid flow rate is controllable through peak period. Disclosed embodiments provide methods and systems to generate the amount of energy that is proportionate to the controlled pressure being exerted upon the wheel/blade assembly 230 to increase rotational speed.

Disclosed embodiments provide reliable and effective methods and systems for generating renewable energy. Certain embodiments provide a dam 600 comprising water source. Other embodiments provide suction lines 418 and return lines 420 communicatively connected to a high pressure water pump assembly 400. Some embodiments of the disclosure comprise the return line 420 being operatively disposed with a turbine assembly 200. The line 420 having openings 421 through which at least a paddle wheel 232 and/or a propeller runner 233 are being connected. The openings 421 further comprised of at least a door 422 being properly sealed. The paddle wheels 232 and/or propeller runner 233 being operatively configured on at least an axle shaft 426. The axle shaft 426 extending outwardly from the door 422, and the paddle wheel 232 and/or propeller runner 233 being inwardly connected to the door 422.

Certain embodiments provide the shaft 426 being configured with a mounting plate/yoke 428. The mounting plate/yoke 428 is being firmly fixed and communicatively connected to the turbine assembly 200. Some embodiments provide the turbine assembly 200 being operatively configured with at least the shaft 426, being disposed with the plate/yoke 428. The plate/yoke 428 is being proportionately bored 429 for connections to the shaft 426 of the paddle wheel 232 and/or propeller runner 233. Disclosed embodiments provide methods and systems comprising advanced configurations to prescribe an enclosed wind and hydropower plant 10. The prescription further comprises advanced wind and hydropower plant 10 configured for effective operations and cost effective maintenance of the turbine assembly 200. Other embodiments of the disclosure comprise at least a reversible pump assembly 400 and or turbine assembly 200 being operatively configured for converting the potential energy stored in the pressured water 423 into mechanical energy for generating electrical energy. Pressure can be directed to substrate-microfiber 724 configured with nano-tubes 714 being communicatively connected to electrodes 716.

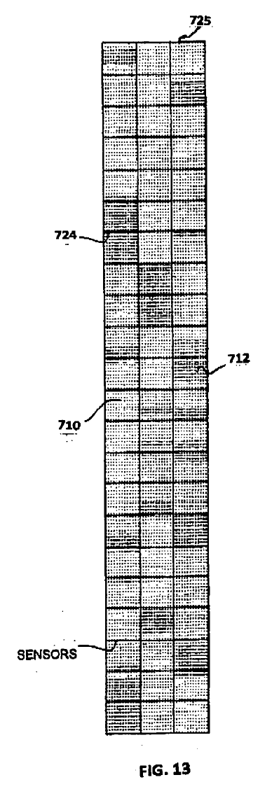

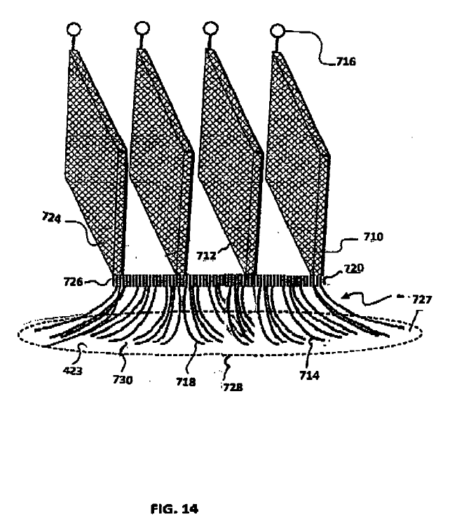

Referring to FIG. 13 is seen exemplary embodiments of nanotechnology application comprising substrate-microfiber 724. Disclosed embodiments provide methods and systems for generating electrical energy, comprising microfiber material 710 being configured with sensors on silicon substrate 712. Certain embodiments of the substrate-microfiber 724 comprise miniaturized non ferrous materials 734 being embedded in the silicon substrate 712. Some embodiments of the substrata-microfiber 724 comprise energy transport platform 725. Certain embodiments of the silicon substrate 712 comprise at least glass 739

Referring to FIG. 14 is seen an exemplary embodiment of energy medium. Disclosed embodiments provide methods and systems for generating and storing electrical energy. Certain embodiments of the disclosure comprise nano-materials 710 comprising microfiber material. Embodiments further provide the microfiber material 710 comprising material with excellent electrical properties disposed with substrate 712. The microfiber material 710 includes material components with nanometer dimensions in which at least one dimension is less than 100 nanometers. Some embodiments provide the microfiber materials further configured with nano-tubes 714, being embedded in the silicon substrate 712. Certain embodiments of the disclosure comprise the substrate 712, being configured with electrodes 716 in communication with the nano-tubes 714. Other embodiments provide the nano-tubes 714 comprising at least one component of carbon char, carbon black, metal sulfides, metal oxides and other organic materials being alloyed with the microfiber material 712. Disclosed embodiments further provide the alloyed microfiber material 712 comprising apparatus 718 configured for exhibiting unique electrical and electrochemical properties to enable efficient transportation of energy properties.

Disclosed embodiments provide methods and systems to produce energy properties from the presence of high surface areas and charge transport mechanism. Certain embodiments provide the charge transport mechanism further derived from the flow of pressured fluid 423. Disclosed embodiments further provide apparatus for thermal expansion in communication with the nano-tubes 714. Certain embodiments of the thermal expansion of the fluid comprise water and/or material pyrolysis. Some embodiments provide energy medium, including apparatus 720 comprising means through which electron transfer occurs at the electrode 716, through the release of chemical energy to create a voltage through oxidation/reduction reactions 722. The oxidation and reduction reactions 722 is being separated through the electron 716. The electrode 716 is being configured with substrate-microfiber 724 comprising re-enforcement to external electric circuits. Certain embodiments provide at least a storage medium, comprising internal voltages at electrodes configured for providing useful energy for batteries 724 and capacitors 726.

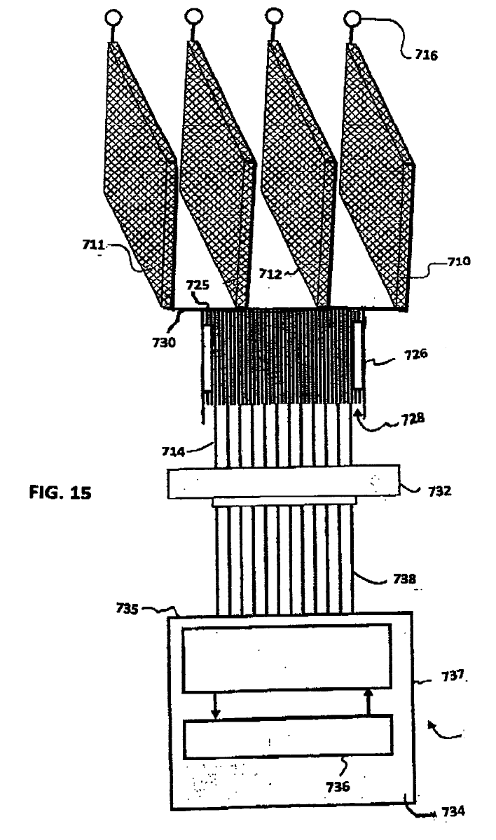

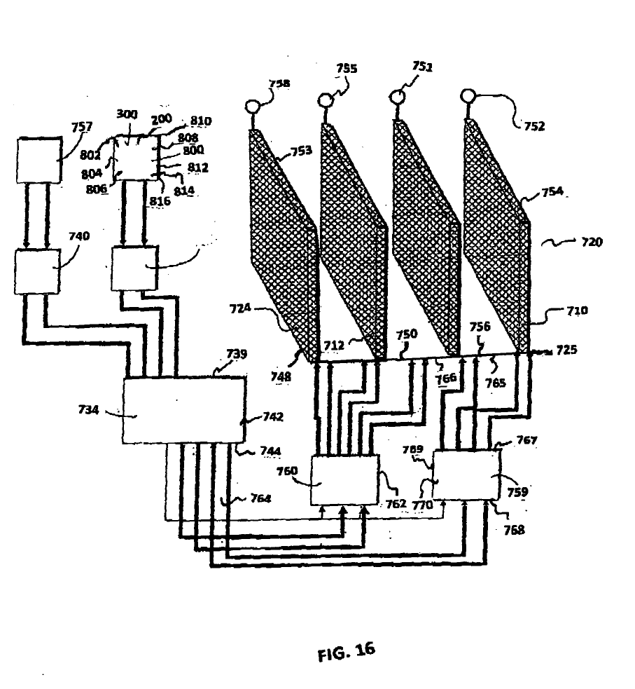

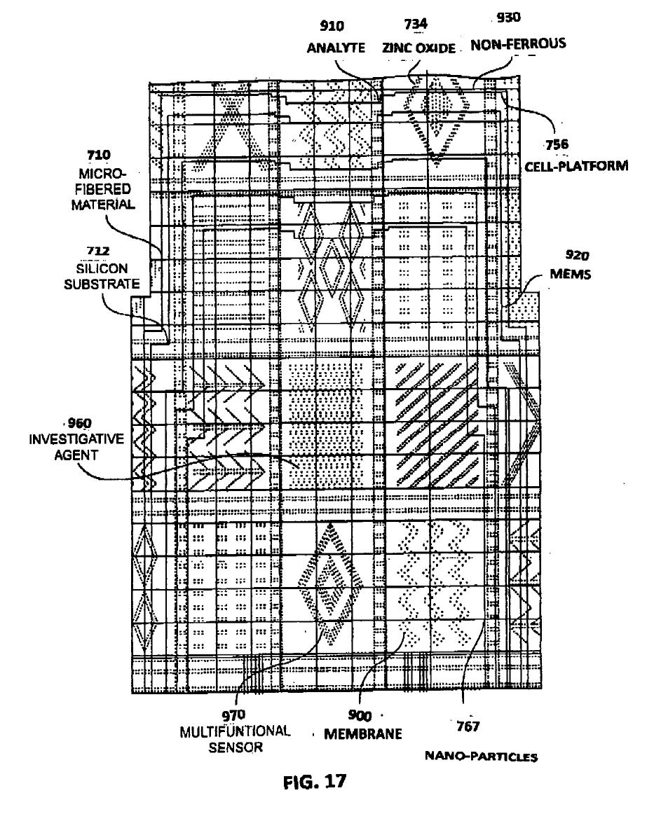

Referring to FIG. 15 is seen further exemplary embodiments of the energy medium comprising energy storage apparatus 720. Disclosed embodiments provide methods and systems for generating electrical energy. Certain embodiments of the disclosure comprise electric current 728 being generated from the energy released by at least a reaction. Certain embodiments of the disclosure comprise microfiber material 710 being configured for converting pressure force and generating energy. Some embodiments of the energy being generated comprise electrical energy 730. Other embodiments of the energy being generated comprise thermal energy 732. The microfiber material 710 further comprises plurality textile fibers 711, being alloyed with zinc oxide (ZnO) nano-wires 734. Disclosed embodiments provide the zinc oxide nano-wire 734 being configured with piezoelectric crystals for generating electrical current 728. Certain embodiments of the disclosure include current flow 730 from plurality fiber pairs 736. Other embodiments provide the fiber pairs being configured for converting at least one of: vibration, pressure, blood flow, sound, waves, force, and other electrical properties into electrical energy 730. Some embodiments provide apparatus for generating pressure and force and converting the pressure and force into electrical energy. Disclosed embodiments provide methods and systems for converting the generated wind and water pressure into electrical energy. The wind and water pressure communicatively connected to microfiber material 710 being configured for converting pressure and force into electrical energy 730. Some embodiments of the microfiber material 710 comprise nanotechnology applications.

Other embodiments provide methods and systems of generating renewable electrical energy through nanotechnology applications. The nanotechnology applications comprise at least plurality layer microfiber 736. Other embodiments of the microfiber 710 further comprise miniaturized material arrays comprising nano-wire 734 being configured for hybrid generator assembly 738. Certain embodiments provide the generator assembly 738 comprising of at least semiconductor properties consisting of non ferrous material arrays. The non ferrous material array comprises vertically-aligned zinc oxide (ZnO) nano-wires 734. The zinc oxide wino-wire 734 is being configured to exhibit flexible electrode 716. Some embodiments provide the flexible electrode further comprising conductive platinum tips 735. Other embodiments provide the microfiber material 710 further comprising plurality fibers with excellent electrical properties, and being coated with polymer and/or with zinc oxide layer 734 to provide energy transport platform 725. Certain embodiments provide the nano-wires 734 being coated with gold 737, and fused or etched on the transport platform 725. Some embodiments provide the nano-wire being configured for harnessing energy from a medium, comprising at least one of: vibration, pressure, blood flow, sound, waves, and, Force. Other embodiments provide apparatus comprising zinc oxide (ZnO) 734 being embedded in a silicon substrate being configured with at least polymer.

Referring to FIG. 16 is seen further exemplary embodiments of the energy medium comprising energy. Embodiments herein provide silicon-substrate-microfiber comprising energy transmission storage apparatus 720. Certain embodiments provide data being converted into electrical energy. The data may be derived from at least one of vibration, pressure, blood flow, sound, waves, force, and electrical properties. Disclosed embodiments further provide the silicon-substrate-microfiber comprising charge couple apparatus 740 being configured with miniaturized conduit particles 734. Certain embodiments of the conduit particles 734 comprise of at least glass 739. Other embodiments of the conduit particle comprise of at least Zinc Oxide (ZnO) and/or gold. Some embodiments of the disclosed particles comprise of at least non-ferrous material being alloyed with at least a substrate-microfiber 724. Disclosed embodiments further provide conduit properties comprising of at least glass fiber 739 being responsive to light data transmission. Further embodiments of the charge particle apparatus 740 comprise electron-silicon substrate-oxide 742 configured with material with good optical properties for exhibiting effective sensitivity to electron range. Disclosed embodiments provide the electron-silicon substrate-oxide 742 comprising coating to prevent glass-glass interface 744. Certain embodiments of the disclosure comprise the silicon substrate 712, being at least the constituent of glass 739. Other embodiments provide the silicon substrate 712 being layered with fibers 710 to exhibit durability and better charged properties.

The electrodes 716 further comprise of battery cells 748. Other embodiments of the battery cells 748 further include electrolyte 750 comprising of cathodes 751 and anodes 752. The cathodes 751 comprising the oxidized form of the electrode metal and the oxidizations and reductions are controlled by the electrochemical potential being responsive to the thermal expansion, pressure, composition and concentration of the electrolyte 750. The electrical potential differenced being produced is the sum of the electrochemical potential at the electrode 716. Embodiments further comprise of Zinc batteries and/or zinc fuel cells 754 being configured for electrochemical power applications through the oxidation of zinc with oxygen from the air for exhibiting high energy density. Certain embodiments comprise nano-materials 734 being embedded in the substrate 712 and etched/fused in the microfiber material 710 to provide advanced cell platform 756. Some embodiments of the cell platform 756 communicatively connected to the electrodes 716. Other embodiments of the cell platform 756 comprise a battery cell 753. Yet, other embodiments of the cell platform 756 comprise fuel cell 754. Disclosed embodiments provide the cell platform 756 further configured for medical devices applications 757. Other embodiments of the cell platform 756 comprise electric vehicles applications 758. Disclosed embodiments further provide the cell platform 736 comprising nickel-cadmium batteries (NiCd) 738 configured with nickel oxide hydroxide and metallic cadmium 760. Embodiments provide the nickel oxide and metallic cadmium 760 further consisting electrodes 716 being configured for deep discharge applications. Other embodiments provide methods and systems for storing electrical energy, comprising the cell platform 756. The cell platform 756 includes battery configuration for higher number of charge/discharge cycles and faster charge and discharge rates. Certain embodiments of the cell platform 756 further comprise an electrode device 762 comprising at least electrically conductive nano tubes 764 being coated with at least one electrically isolating layer 765. Embodiments further provide nano-tubes 764 comprising at least a substrate 712 being coated with at least one metallic layer 760 having a nano-metric pattern thereon, and being at least partially exposed at a tip of said electrically conductive core 760. The cell platform 754 further comprises at least plurality nano-tubes 764 being configured with flexible electrode devices 762 disposed in a guided re-enforced silicon substrate 712. Other embodiments further provide each electrode device 764 being configured with plurality of micro-wires 734 being connected to at least one nano-tube. The nano-tubes 762 further comprise flexible electrode devices 762 being configured to provide electrical communications.

Disclosed embodiments further provide the cell platform 756 comprising particles of zinc mixed with an electrolyte consisting of at least potassium hydroxide solution: water, and oxygen from the air to enable reaction at the cathode 751. The reactions can form hydroxyls, which is being migrated into zinc paste and form zinc oxide hydroxide 734 configured for releasing electrons to the cathode 751. Disclosed embodiments further provide reactions comprising zinc decaying into zinc oxide 734 to provide the releasing of water back into the cell platform 756. The cell platform 756 is being configured so that the water and hydroxyls from the anode 752 are being recycled at the cathode 751. The recycling of the water and the hydroxyls enables the water 766 to serve only as a catalyst to produce maximum voltage. The disclosure of the substrate 712 and microfiber material 710 for the cell platform 756 further comprises electro-active material to enable better charge transport. The cell platform 756 further comprise of plurality nano-components consisting of nano-particles 767 forming conductive carbon-based nano-clusters 768 bound together by a conductive carbon-based cluster binder having high densities of mobile charge carriers such as electrons, electronic acceptors, ionic species. The cell platform 756 further comprises at least a terminal 769, being electrically coupled to the nano-particles 768 for enabling a charge transport and for supplying electrons and electron acceptor sites. Other embodiments of the cell platform 756 further comprise charge transport 740, occurring by means of the electron traveling through the highly conductive and short path of the binders 770. Disclosed embodiments provide the binders in close proximity with the nano-clusters 768 for enhancing the energy and power densities.

Disclosed embodiments further comprise an enclosed turbine assembly 200 consisting of electric generator device being configured with a cell platform 756. The turbine assembly 200 includes one or more generators 300 each comprising au electric generator machine 800. The electric generator machine 800 includes a stator 802 and a rotor 804. Certain embodiments of the disclosure include the rotor 804 comprising an inductor 806 being configured with a ring bearing 808 comprising apparatus for the distributing magnetic poles along a periphery. The rotor 804 further comprises at least central bearing consisting of one or more fan blades 810. The stator 802 being configured with the rotor 804, comprising bearing windings 812, being communicatively connected to link the magnetic field 814 generated by the magnetic poles 816 when the rotor 804 is caused to rotate without resistance, and at relatively higher speed by a fluid flow from the fluid generating machine 100. The flow pressure is directed for activating the fan 810, being supported by the rotor 804, in rotation by the stator 802 through at least a magnetic means of support. Disclosed embodiments further comprise the rotor 804 being centrally configured with opening solely occupied by one or more fan blades 810 responsive to said controlled fluid flow directed parallel/axially to the axis of the rotor 804 by said fluid generating machine 100. Some embodiments provide the turbine assembly 200 being communicatively connected to the cell platform 756. Certain embodiments of the cell platform 756 comprise at least a transformer 755. Other embodiments provide the turbine assembly 200 communicatively connected to grids 820.

Embodiments provide the Wind and Hydropower plant, comprising a renewable energy source that requires no fuel to operate and does not produce any emissions that are harmful to the environment. Disclosed embodiments provide the wind turbines being further made of plastic and metallic materials to prevent any radioactive or chemical impact within the environment. Disclosed embodiments further provide the ventilation apparatus configured for extracting the outside wind to operate the enclosed wind turbine blades. The inflow of air is controllable through the operation of the ventilation apparatus, and the turbines take up much less space than conventional wind farms. Disclosed embodiments provide methods and systems that don't produce noise and pollution.

Electricity produced from disclosed embodiments is cost effective because the wind could be regenerated when there is no wind and more electricity could be generated at any period than that produced from traditional sources like conventional wind flunks, natural gas, nuclear power and coal. Maintenance coast for disclosed embodiments is lower, and at best, produces electricity at an efficiency rate far better than conventional wind farms, natural gas nuclear plants and coal. The enclosed wind energy plant is more reliable because the wind could be regenerated when there is no wind. The plant could be operable in every environment, including deserts and icy environment because of the operational configuration and characteristics such as enclosable, controllable wind and thermal adjustment. Electricity could be stored or be produced on demand. The wind is predictable and controllable to produce enough available electricity to meet demands.

Referring to FIG. 17 is seen exemplary embodiments of a charge transport comprising microfiber material 710 being configured with silicon substrate 712. The silicon microfiber comprises cell platform 756. The cell platform 756 comprises nonferrous material 930 embedded in the silicon substrate 712. Multifunctional sensors 970 and MEMS 920 are embedded in the silicon substrate for detection of charge characteristics. The cell platform 756 further comprises nano particles 767 being configured with membranes 900. Disclosed embodiments provide methods and systems for generating electrical energy and for transporting the energy. Some embodiments provide zinc oxide 734. Certain embodiments comprise an analyte 910. Other embodiments provide an investigative agent.

While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure.

What is claimed:

1. An enclosed energy plant; comprising:
at least a building structure;
at least a turbine assembly; and
at least apparatus for generating pressure force.

2. An enclosed energy plant of claim 1, wherein said building structure comprises at least one of: a horizontal member, a vertical member, and an angular member.

3. An enclosed energy plant of claim 1, wherein said at least one member comprising an opening in at least a portion of the structure.

4. An enclosed energy plant of claim 3, wherein said opening comprises at least a fluid flow pressure entrance channel.

5. An enclosed energy plant of claim 3, wherein said opening further comprises at least a fluid flow pressure exit channel.

6. An enclosed energy plant of claim 3, wherein said apparatus being disposed on at least one said member.

7. An enclosed energy plant of claim 1, wherein said apparatus being configured for accelerating said fluid flow pressure via said entrance channel.

8. An enclosed energy plant of claim 1, wherein said apparatus being configured for accelerating said fluid flow pressure via said exit channel.

9. An enclosed energy plant of claim 1, wherein said apparatus being configured to accelerated said fluid flow pressure from said entrance channel to said exit channel.

10. An enclosed energy plant of claim 3, wherein said turbine assembly being secured on at least one said member.

11. An enclosed energy plant of claim 1, wherein said turbine assembly responsive to said fluid flow pressure for generating electrical energy.

12. An enclosed energy plant of claim 1, wherein said building structure disposed with at least a control apparatus.

13. An enclosed energy plant of claim 1, wherein said control apparatus being configured with said apparatus for controlling the flow rate of said fluid.

14. An enclosed energy plant of claim 1, wherein said control apparatus being configured for controlling the thermal condition of said building structure.

15. An enclosed energy plant of claim 1, wherein said fluid flow pressure comprises at least air/wind pressure.

16. An enclosed energy plant of claim 1, wherein said fluid flow pressure comprises water pressure.

17. An enclosed energy plant of claim 1, wherein said water pressure being propelled by at a pump.

18. An enclosed energy plant of claim 1, wherein said fluid flow further being channeled to at least a tunnel.

19. An enclosed energy plant of claim 1, wherein said tunnel being configured with at least a turbine assembly.

20. An enclosed energy plant of claim 1, further comprising ventilation apparatus configured for generating fluid pressure in communication with at least a turbine assembly.

21. Apparatus for generating and storing electrical energy; comprising: at least a substrate; and at least a microfiber material.

22. Apparatus for generating and storing electrical energy of claim 21, wherein said substrate further comprises glass.

23. Apparatus for generating and storing electrical energy of claim 21, further comprising cell platform.

24. Apparatus for generating and storing electrical energy of claim 21, said cell platform further comprising non-ferrous material.
